(19) United States
(12) Patent Application Publication
(10) Pub. No.: US 2024/0072292 A1
(43) Pub. Date: Feb. 29, 2024

(54) BATTERY ASSEMBLY AND RELATED WELD TECHNIQUES

(71) Applicant: Gridtential Energy, Inc., Santa Clara, CA (US)

(72) Inventor: Daniel Jason Moomaw, Santa Clara, CA (US)

(21) Appl. No.: 18/280,077

(22) PCT Filed: Mar. 3, 2022
(86) PCT No.: PCT/US2022/018723

§ 371 Date: Sep. 1, 2023

Related U.S. Application Data
(60) Provisional application No. 63/200,416, filed on Mar. 5, 2021.
(60) Provisional application No. 63/200,417, filed on Mar. 5, 2021.

(51) Int. Cl. H01M 10/04; H01M 50/209; H01M 50/264

(52) U.S. Cl. CPC H01M 10/0418; H01M 10/0481; H01M 50/209; H01M 50/264

(57) ABSTRACT

A battery assembly, such as a bipolar battery assembly can be fabricated using an optical welding process. For example, a stack of biplate assemblies can be assembled including aligning the biplate assemblies using a fixture, the fixture having at least one feature sized and shaped to engage a corresponding feature in a first casing portion in the stack of biplate assemblies. The stack of biplate assemblies can be compressed. A second casing portion comprising an optically-transmissive region can be mated to the first casing portion. An optically-absorbing region of the first casing portion can be irradiated through an optically-transmissive portion of the second casing portion to form a weld structure along at least one edge of the second casing portion.

### CLAIM OF PRIORITY

This patent application claims the benefit of priority of Daniel Jason Moomaw, U.S. Provisional Patent Application No. 63/200,416, titled “BATTERY ASSEMBLY AND RELATED WELD TECHNIQUES,” filed on Mar. 5, 2021 (Attorney Docket No. 3601.029PRV), and the benefit of priority of Daniel Jason Moomaw, U.S. Provisional Patent Application No. 63/200,417, titled “BATTERY ASSEMBLY AND RELATED WELD TECHNIQUES,” also filed on Mar. 5, 2021 (Attorney Docket No. 3601.029PV2), the entireties of each of which are hereby incorporated by reference herein.

### FIELD OF THE DISCLOSURE

This document pertains generally, but not by way of limitation, to battery assemblies, such as lead-acid battery assemblies, and more particularly to assembly techniques and casing configurations that can be used for battery assemblies.

### BACKGROUND

The lead acid battery, invented by Gaston Plante in 1859, can be considered the oldest and most common type of secondary (e.g., rechargeable) battery. Applications for lead acid batteries include automotive (e.g., starting, ignition, and lighting), traction (e.g., vehicular drive), and stationary (e.g., back-up power supply) applications. Despite simplicity and low cost, generally-available monopolar lead acid technology has several shortcomings related to architecture and materials used in the battery. For example, generally-available monopolar lead acid batteries have relatively lower energy densities as compared to other chemistries such as lithium ion partly because the lead alloy grids do not contribute to energy storage capacity. Also, cycling performance of monopolar lead acid batteries may be poor under high-current-rate or deep discharge conditions. In addition, monopolar lead acid batteries may suffer from poor partial-state-of-charge performance, and often have high self-discharge rates relative to other technologies.

### SUMMARY OF THE DISCLOSURE

A bipolar battery architecture offers improvements over a monopolar battery configuration. In a bipolar configuration, because cells are arranged electrically in series to multiply the cell voltage, current flows in a direction generally perpendicular to the surface of the plates. Fabrication of a bipolar battery generally involves forming a bipolar current collector to provide a substrate material (e.g., a conductive substrate). Positive and negative active materials are applied to at least a portion of opposite surfaces of the bipolar current collector to provide a bipolar plate or “biplate.” Generally, multiple bipolar plates are compressed and stacked alternately with separators to establish individual cell compartments, which are to be isolated from each other. Each cell compartment is populated with electrolyte (e.g., a liquid or gel electrolyte), and the battery stack can be formed to activate the cathode and anode materials. In the bipolar configuration, the current collector itself (e.g., the conductive substrate) provides an inter-cell electrical connection, with the anode of one cell conductively coupled to the cathode of the next cell on the opposite side of the bipolar current collector via the current collector substrate.

The present inventor has recognized, among other things, that fabricating a battery assembly, such as a bipolar battery assembly, can include placing a stack of modules or bipolar plate (e.g., “biplate”) elements in compression and keeping such a stack captive in compression during or after a welding operation. The biplate elements can include features to align such elements in a fixture or jig for one or more of initial assembly or welding. In an illustrative example, the welding operation can include a lap joint or other weld structure. The lap joint or other weld structure can affix a plate or frame to at least one face of the stack, with the stack captive after such welding. The plate or frame can be placed in compression during assembly, and in tension by the stack after assembly. The welding process can include an optical (e.g. laser) welding technique where the lap joint or other weld is formed by transmitting optical energy through a portion of the battery assembly, such as through the plate or frame being affixed to the stack. In another approach, another welding technique such as hot-plate welding can be performed using the fixturing and other aspects of the subject matter described herein.

In an example, a method for fabricating a battery assembly can include assembling a stack of biplate assemblies including aligning the biplate assemblies using a fixture, the fixture having at least one feature sized and shaped to engage a corresponding feature in a first casing portion in the stack of biplate assemblies, compressing the stack of biplate assemblies, mating a second casing portion comprising an optically-transmissive region to the first casing portion, and irradiating an optically-absorbing region of the first casing portion through an optically-transmissive portion of the second casing portion to form a weld structure along at least one edge of the second casing portion. The irradiating can include using a laser to thermally form the weld structure. In another approach, a non-optical welding technique can be used, such as hot plate welding.

In an example, a method for fabricating a battery assembly can include assembling a stack of biplate assemblies including aligning the biplate assemblies using a fixture, the fixture having at least one feature sized and shaped to engage a corresponding feature in a first casing portion in the stack of biplate assemblies, compressing the stack of biplate assemblies, mating a panel comprising an optically-transmissive region to the first casing portion, securing the compressed stack of biplate assemblies by end structures applied to the compressed stack of biplate assemblies, the end structures fastened to a fixture that aligns the compressed stack of biplate assemblies, and irradiating an optically-absorbing region of the first casing portion through an optically-transmissive portion of the panel using a laser to thermally form a weld structure along at least one edge of the panel. The end structures (e.g., top and bottom end plates), the fixture, and the compressed stack form a unitized assembly. As an illustration, the biplate assemblies can include respective first casing portions (e.g., modular casing portions), the respective first casing portions comprising modular casing frames, the modular casing frames supporting a conductive substrate clad with active materials on opposing surfaces of the conductive substrate, the active materials having opposite polarities.

In an example, an assembly can include two or more biplate assemblies, a fixture comprising at least one feature sized and shaped to engage a corresponding feature in the two or more biplate assemblies to align the biplate assemblies in a stack for a welding operation, and respective end structures fastened to the fixture to maintain compression of the two or more biplate assemblies. The fixture can define an aperture permitting mating of a second casing portion comprising an optically-transmissive region to respective first casing portions of the two or more biplate assemblies.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A illustrates generally an example showing a monopolar battery architecture.

FIG. 1B illustrates generally an example showing a battery assembly having a bipolar architecture.

FIG. 2 illustrates generally an example comprising a planar bipolar battery plate, such as having a conductive substrate including opposing surfaces that can support active materials having opposite conductivity types.

FIG. 3 illustrates generally a sub-assembly comprising a planar bipolar battery plate, such as supported by a modular casing portion.

FIG. 4 illustrates generally a battery assembly comprising stacked modular casing portions and panels that can be affixed to the stacked modular casing portions.

FIG. 5 illustrates generally a cut-away view of a portion of a battery assembly showing an internal configuration of the battery assembly along with a technique that can be used to affix a side panel to the battery assembly.

FIG. 6 illustrates generally fixturing that can be used to align and stack modular sub-assemblies for constructing a battery assembly.

FIG. 7 illustrates a side view showing crush rib structures that can be used to help align and separate respective modular casing portions when modular sub-assemblies are stacked for constructing a battery assembly.

FIG. 8 illustrates generally further fixturing that can be used to assist in constructing a battery assembly.

FIG. 9A illustrates generally a technique for applying compression to the stacked battery assembly of FIG. 8.

FIG. 9B illustrates generally a technique for maintaining compression of a stacked battery assembly after compression.

FIG. 10 illustrates generally a technique for affixing one or more panels to a battery assembly.

FIG. 11 illustrates generally a battery assembly such as can be constructed using one or more techniques described elsewhere herein.

FIG. 12 illustrates generally a technique, such as a method, for fabricating a battery assembly.

### DETAILED DESCRIPTION

As mentioned above, the lead acid battery can be considered the earliest type of rechargeable battery, and lead acid chemistry remains the most commonly-used battery chemistry. The active materials in a lead acid battery generally include lead dioxide (PbO₂), lead (Pb), and sulfuric acid (H₂SO₄) which also acts as the electrolyte. To assemble a lead acid battery having a monopolar architecture, PbO₂ and Pb active materials can be pasted and cured onto monopolar lead current collectors to provide positive and negative plates, from which an electrochemical cell can be formed with H₂SO₄ electrolyte. The cells are generally arranged electrically in a parallel configuration such that the voltage of the battery is proportional to the number of cells in the battery assembly. Manufacturing of a monopolar lead acid battery may include a few basic operations. The base material for current collector grids may include lead along with elements other than lead metal alone, such as to provide an alloy to improve mechanical properties without affecting electrochemical characteristics. However, alloying elements or compounds may promote side reactions during battery operation. As side reactions compete with the electrochemical reactions of charging and discharge, battery performance can be degraded. After the grids are formed, one of a positive or negative active material is applied (e.g., “pasted”) onto respective grids to provide monopolar battery “plates,” and the plates are then cured. The pasted and cured positive and negative plates can be stacked alternately with separators to form “plate-blocks,” which are electrochemical cells with multiple electrodes connected electrically in parallel. A multi-cell battery may be constructed by connecting multiple plate blocks electrically in series, in which the blocks are compressed

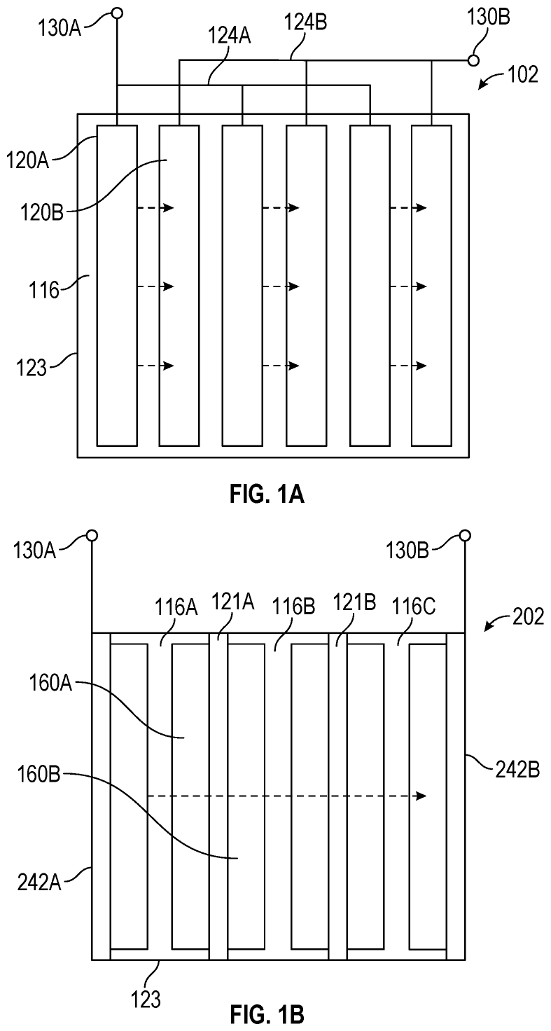

FIG. 1A illustrates generally an example that can include a monopolar battery architecture. In a monopolar configuration, a current collector generally includes an active material of a single polarity (e.g., positive or negative) applied to both (e.g., opposite) sides of the current collector, such as including application of the active material in paste form. A positive-negative pair can be formed such as including the first plate 120A having a first polarity active material and a second plate 120B having an opposite second polarity active material, to form an electrochemical cell when surrounded in an electrolyte in region 116, such as shown illustratively in FIG. 1A. In a lead-acid example, such a single-cell voltage can be around 2.1V. Multiple cells can be arranged electrically in parallel configuration as a stack (e.g., a plate block). Individual stacks through can be connected in series to provide a battery assembly 102. In FIG. 1A, a first terminal 130A can provide a first polarity, and a second terminal 130B can provide an opposite second polarity.

FIG. 1B illustrates generally an example showing a battery assembly 202 having a bipolar architecture. In the bipolar configuration, because cells are arranged electrically in series to multiply the cell voltage, current flows in a direction generally perpendicular to the surface of the current collector plates. Generally, fabrication of a bipolar battery involves forming a current collector comprising a substrate material (e.g., a conductive substrate) where positive and negative active materials are applied to at least a portion of opposite surfaces of the current collector to provide a bipolar plate or “biplate.” Generally, multiple bipolar plates are compressed and stacked alternately with separators to establish individual cell compartments, which are to be isolated from each other. Each cell compartment is populated with electrolyte (e.g., a liquid or gel electrolyte), and the battery stack can be formed to activate the cathode and anode materials. In the bipolar configuration, the current collector itself (e.g., the conductive substrate) provides inter-cell electrical connection, with the anode of one cell conductively coupled to the cathode of the next cell on the opposite side of the bipolar current collector via the current collector substrate.

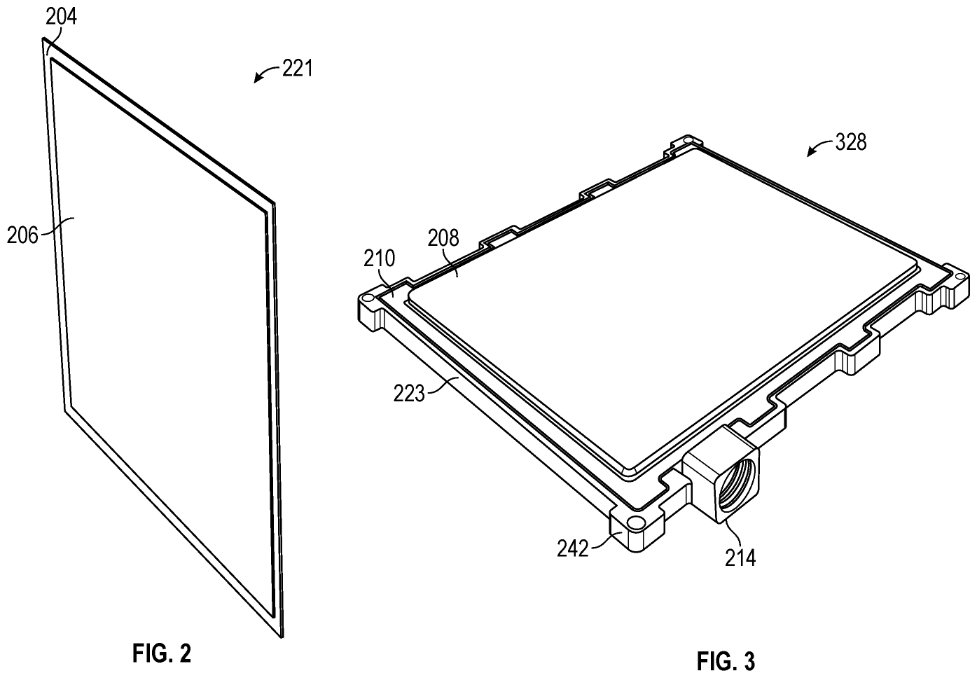

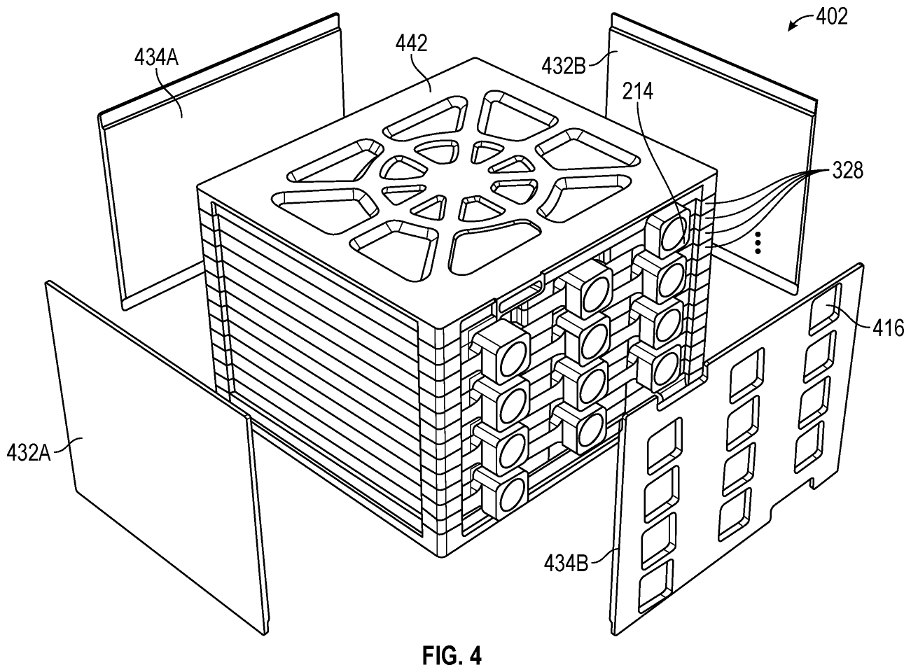

Referring to FIG. 1B, a bipolar architecture can provide a simpler configuration as compared to a monopolar architecture. Respective positive and negative active materials (e.g., active materials represented by regions 160A and 160B) can be applied, such as through pasting, onto opposite sides of a current collector (e.g., plate 121A) to form a bipolar plate. As in FIG. 1A, a first terminal 130A can provide a first polarity, and a second terminal 130B can provide an opposite second polarity. Such terminals 130A and 130B can be connected to end electrodes 242A and 242B, respectively. The bipolar plates 121A, 121B can be arranged in a stacked configuration with electrolyte in regions 116A, 116B, and 116C for example, to form sealed cells within a casing 123. In an example, an electrolyte in region 116A can be one or more of fluidically isolated or hermetically sealed so that electrolyte cannot bypass the bipolar plate 121A to an adjacent region such as the electrolyte region 116B, or to suppress or inhibit leakage of electrolyte from the assembly 202. As shown illustratively in FIG. 1B, cells can be arranged in a series configuration forming a stack to achieve a specified terminal 130A, 130B voltage, without requiring internal bus structures. As an illustrative example, each bipolar plate can be mechanically attached to a casing portion (e.g., a modular casing frame), such as supporting a bipolar plate 221 as shown in FIG. 2 and having a modular (e.g., stackable) configuration as shown in FIG. 3 and elsewhere herein.

FIG. 2 illustrates generally an example comprising a planar bipolar battery plate 221 (e.g., a biplate), such as having a conductive substrate 204 including opposing surfaces that can support active materials having opposite conductivity types. Electrochemically, the bipolar battery plate 221 current collector surface is generally specified to have a wider and more stable potential window as compared to the charge and discharge electrochemical reactions of the battery. Specifically, in the example of a lead acid chemistry, the cathode and anode surfaces are generally specified to have higher oxygen and hydrogen evolution over-potentials than those on PbO₂ and Pb, respectively, and the over-potentials are specified to be relatively stable throughout the lifetime of the battery. The high over-potentials can help to reduce or minimize gas evolution due to water electrolysis side reactions at the electrodes. Such side reactions can lead to one or more of coulombic efficiency reduction, active material loss, capacity fade, or premature failure of the battery.

Selection of substrate 204 materials for bipolar lead acid batteries can present various challenges. Although lead metal can be used as a substrate 204, lead is a relatively soft metal, and it corrodes in H₂SO₄. Most other metals, although electronically conductive, either corrode or passivate in H₂SO₄. Composite materials, despite having a wide variety of composition and property options, often suffer from one or more of low electronic or high ionic conductivities. Silicon can be used, such as a substrate 204, for a current collector for a bipolar lead acid battery. For example, silicon wafers are readily available in different sizes and shapes and are widely used in different industries. Mono-crystalline or poly-crystalline silicon are generally impervious to H₂SO₄ and can be doped to achieve a specified conductivity. Although an insulating oxide can form on a silicon surface, a variety surface modification processes can be used to provide desired chemical and electrochemical surface properties. For example, a metal silicide can be formed on a silicon surface by annealing a metal thin film deposited on the surface. A metal silicide generally forms a low resistivity ohmic contact with the silicon, protects the underlying silicon from oxidation or passivation, and extends an electrochemical stability window of the surface. One or more thin films can be deposited onto the substrate 204 to enhance its surface properties relating to active material adhesion, such as one or more thin films deposited after silicide formation to provide a first surface 206 and a second surface opposite the first surface, suitable for application of an active material. For example, the first surface 206 can include lead or a tin-lead combination.

Generally, a battery assembly, such as a bipolar battery assembly, can be fabricated from sub-assemblies in a modular manner. Such a modular approach facilitates fabrication of battery assemblies having different capacities or output voltages. For example, FIG. 3 illustrates generally a sub-assembly 328 comprising a planar bipolar battery plate (such as the plate 221 configuration shown in FIG. 2), such as supported by a modular casing portion 223 (such as can be referred to as a casing frame). The plate 221 of FIG. 2 can have positive and negative active materials (PAM and NAM) applied, such as prepared and applied in paste form by mixing lead metal (e.g., sponge lead) or lead oxide powder, sulfuric acid, and various additives. The composition of the components, especially the types and amounts of various additives, differ for positive and negative active materials. For example, red lead is sometimes added to PAM, whereas carbon additives are common in NAM. In the example of the sub-assembly 328 of FIG. 3, a separator or absorbed glass mat 208 can be included, such as applied to an active material on a surface of the biplate. The sub-assembly 328 can also provide a seal such as a gasket 210 to assist in isolating electrolyte regions from each other when stacked. In a stacked configuration, the modular casing portion 223 need not be identical to other similar casing portions in a battery stack. For example, different modular casing portions (e.g., stackable casing frame elements) can have different or staggered vent locations with respect to each other, or even no vent. Such differing or staggered vent locations can provide clearance for portions of the vent protruding above or below the casing portion 223 when stacked with other casing portions to provide a bipolar battery assembly. In the example of FIG. 3, and other examples herein, the casing portion 223 includes one or more features such as a feature 242 located at a corner of the casing portion 223, such as for use in alignment of the casing portion 223 with other casing portions or elements in the battery assembly during or after stacking.

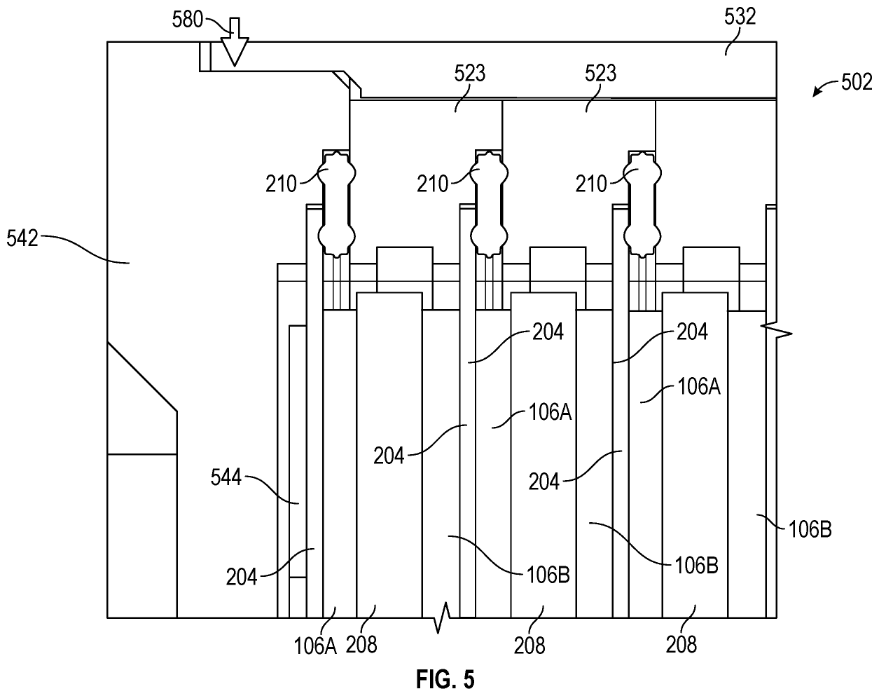

FIG. 4 illustrates generally a battery assembly 402 comprising stacked modular casing portions and panels that can be affixed to the stacked modular casing portions. In the example of FIG. 4, the battery assembly 402 is formed from similar sub-assemblies 328, such as having casing portions that need not be identical. Once the stack is assembled and compressed, such as using fixturing as shown and described below, one or more panels can be affixed to the battery assembly 402. Such panels can include side panels 432A, 432B, a bottom panel 434A, or a top panel 434B, or a combination of such panels. The panels 432A, 432B, 434A, and 434B can assist in maintaining compression of the battery assembly 402 after fixturing is removed, such as for a remainder of the life of the battery. End portions of the casing, such as a housing an end electrode 442 region need not have panels. As shown above in FIG. 4, one or more of the panels can include apertures, such as to accommodate mechanical features of the battery stack such as vent regions. For example, the top panel 434B can include a respective aperture 416 to accommodate a respective vent 214. One or more such panels 432A, 432B, 434A, and 434B can be affixed using a lap-weld at a shoulder of such panels. For example, laser welding or other bonding can be performed, such as to establish welded joints between respective panels and the battery assembly. As an illustrative example, optical energy such as generated by a laser can pass through an optically transparent structure (such as optically transparent at a specified range of wavelengths of such optical energy), such as a panel 432A, 432B, 434A or 434B. The optical energy can be absorbed by a layer below the panel (e.g., comprising a casing segment included as a portion of a sub-assembly 328 or other portion of the battery assembly). In this manner, a welded joint between the panel and the remainder of the battery assembly is provided when heating occurs of the region where the panel 432A, 432B, 434A or 434B and casing portion are in contact.

Various examples described in this document mention use of optical energy such as generated by a laser, to affix panels 432A, 432B, 434A or 434B to a battery assembly 402. Other approaches can be used to bond the panels 432A, 432B, 434A or 434B, such as using a hot-plate welding technique where the hot-plate is applied in an exposed region of the panels 432A, 432B, 434A or 434B, such as defined by an opening (e.g., window) or aperture in fixturing elements such as the fixturing shown and described below.

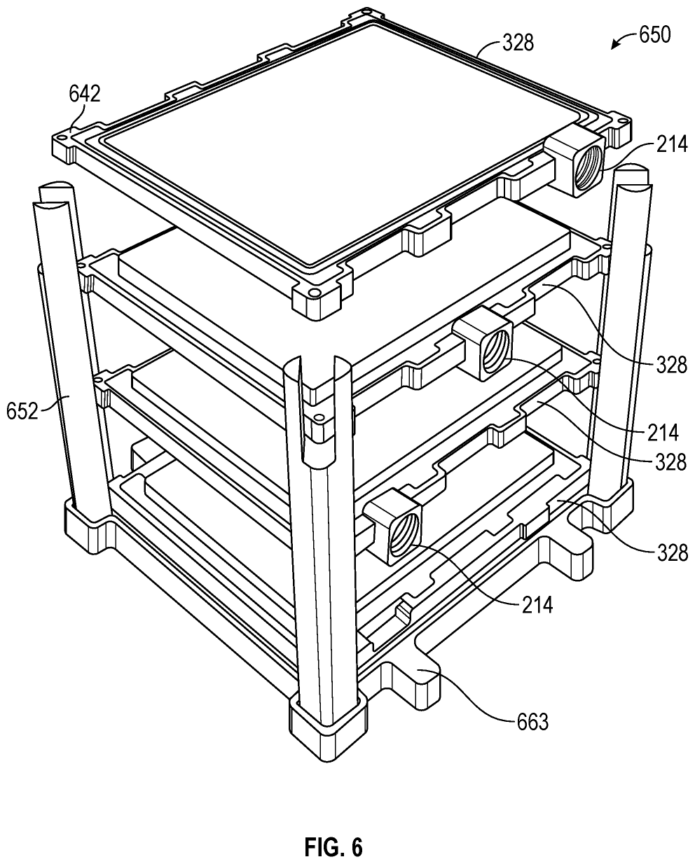

For example, FIG. 5 illustrates generally a cut-away view of a portion of a battery assembly 502 showing an internal configuration of the battery assembly along with a technique that can be used to affix a side panel to the battery assembly. In the example of FIG. 5, the stack of elements includes an end electrode assembly 542, and sub-assemblies comprising modular casing portion 523. The end electrode assembly 542 and sub-assemblies can be sealed from each other or from surroundings in part using a perimeter gasket 210. The modular casing portions 523 can support a conductive substrate 204, such as a silicon substrate, and active materials 106A and 106B as discussed above, to provide bipolar current collector structures. An electrolyte region between active materials can include an absorbed glass mat (AGM) 208 separator. Each region with an AGM 208 separator can be hermetically isolated from other such regions 208. An end electrode 544 can be included as a portion of the end electrode assembly 542, such as to collect current and provide an electrical structure to which a terminal can be bonded.

In the view shown in FIG. 5, a panel 532 can be affixed to the battery assembly 502, such as using optical energy 580, such as a collimated beam from a laser. The panel 532 can be optically transparent within a specified range of wavelengths, and the optical energy 580 can be provided within such a range. As an illustrative example, a thickness of the panel 532 where the welding is performed can be less than 2 millimeters (mm), such as about 1.8 millimeters, and the panel can be less than 4 mm thick elsewhere, such as about 3.3 mm thick. A width of the lap joint can be about 9 mm. Lap joints such as at the location where the optical energy 580 is applied can be established at a perimeter of the panel 532. The gaskets 210 can used for sealing can be pre-fabricated or can include deposition or dispense of an adhesive or sealant (or a combination of pre-fabricated and formed-in-place materials). For example, a bead or region of an adhesive can be formed, such as including an epoxy or other material. Accordingly, the side panel 532 need not provide a hermetic joint, but the side panel 532 can be used to help maintain compression of the assembly (including loading or compressing the gaskets 210 or other seal materials) to maintain hermeticity by such compression. Generally, the compression can be maintained by the rigidity of the side panel 532 even when such compression is in a direction perpendicular to the plane of the side panel (e.g., the compression is maintained in a direction perpendicular to the weld such as loading the weld structure in shear). As mentioned above, use of optical energy 580 is one approach, and other approaches such as hot-plate welding, can be used.

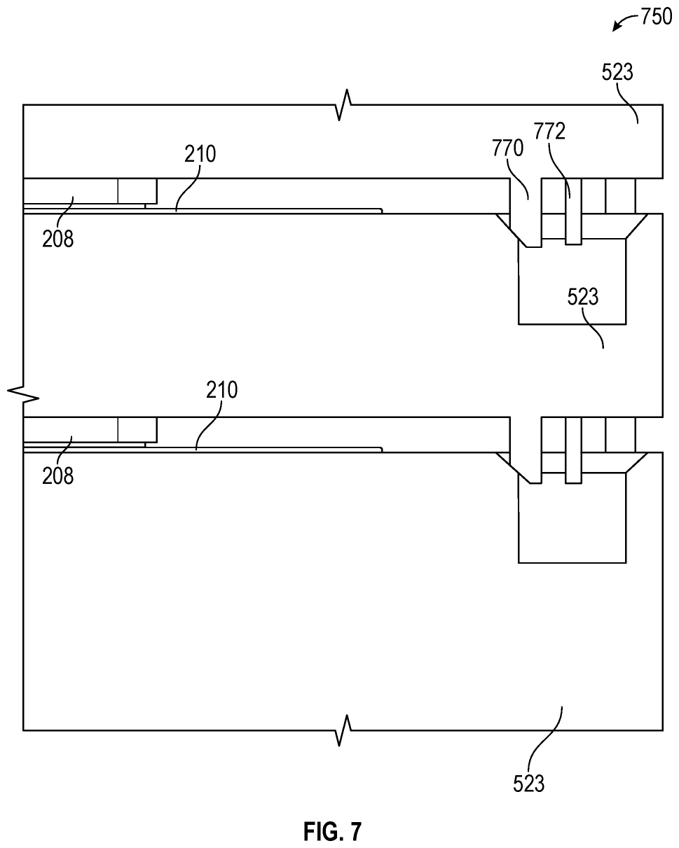

FIG. 6 illustrates generally fixturing 650 that can be used to align and stack modular sub-assemblies 328 for constructing a battery assembly. The fixturing 650 can include one or more posts such as a post 652 including or defining an interior rail or other feature that aligns with a corresponding feature 642 included as a portion of a casing frame in the sub-assembly 328. The feature 642 can also define step or other feature to aid in alignment or placement of a side panel during a later operation, such as to provide a flush or near-flush outer surface between an applied panel and the feature 642. As mentioned above, respective sub-assemblies 328 can have vent 214 locations that are staggered as shown to avoid mechanically interfering with each other when stacked and aligned within the fixturing 650. End plates such as a base plate 663 can be included to support or retain posts such as the post 652.

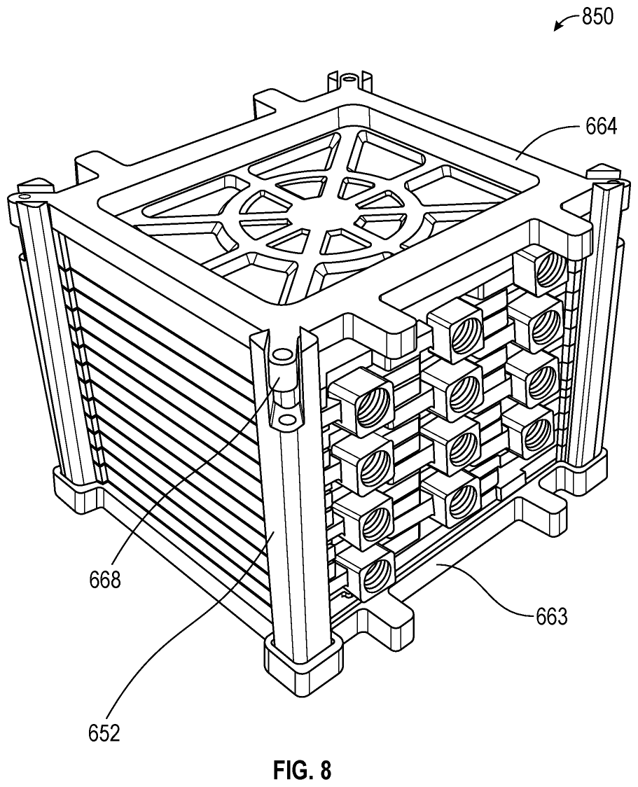

FIG. 7 illustrates a side view 750 showing crush rib structures 770 and 772 that can be used to help align and separate respective modular casing portions 523 when modular sub-assemblies are stacked for constructing a battery assembly. The sub-assemblies can be separated from each other or otherwise spaced apart during assembly by ribs such as structures 770 and 772 or other structures. Crush rib structures can be defined as protrusions from one casing frame or other stackable element that align with a cavity or other feature in another modular casing portion 523 or other stackable element. The protrusions (e.g. rib structures 770 or 772) can maintain alignment and stand-off between adjacent elements during assembly. When compressed, such as discussed below, such ribs can be deformed or can otherwise become displaced or captive within a corresponding cavity or other feature in an adjacent modular casing portion 523. Such crush features can also help smooth an application of compression to the stack, such as encouraging uniform yielding of such features as compression is applied, and such as providing such yielding in a gradual manner rather than abruptly yielding. A seal 210 between adjacent casing portions 523 can provide a hermetic seal isolating AGM 208 or other electrolyte regions from each other or from the surroundings.

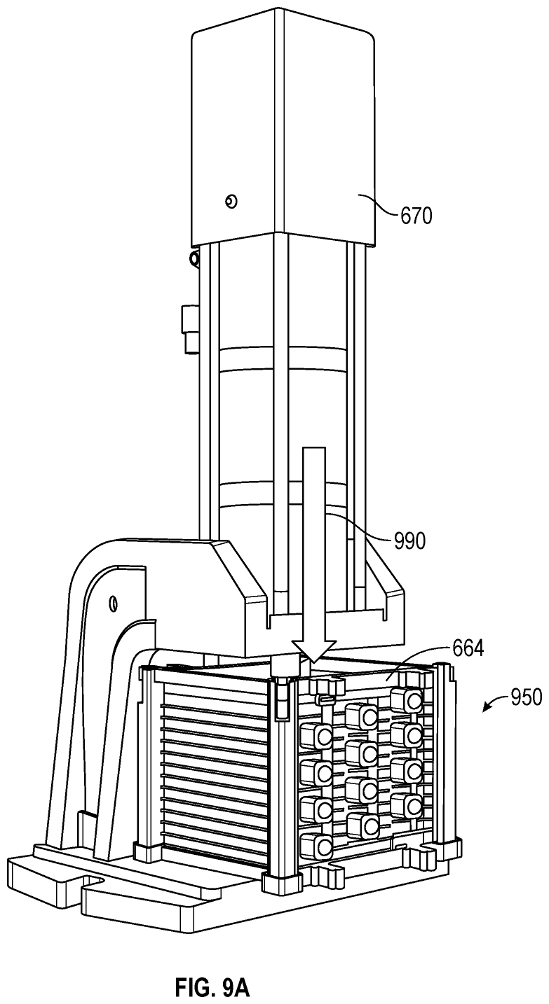

FIG. 8 illustrates generally further fixturing 850 that can be used to assist in constructing a battery assembly. As in the examples above, one or more posts such as a post 652 can align with portions of the battery assembly to facilitate stacking of sub-assemblies. A base plate 663 can support the one or more posts 652 and a top end-plate can be inserted in the stack, such as including a feature 668 received by or otherwise aligning with fingers or other features in a respective post 652. The end plates 664 and 663 can be used to apply compression to the stacked sub-assemblies, such as before, during, or after a welding operation to affix one or more side panels. For example, the fixturing 850 can define apertures between respective posts 652, such as in which a side panel can be placed as shown generally in FIG. 4. The plates 664 and 663 can serve to distribute pressure in a controlled manner across specified locations in the stack, such as around a perimeter of the top face of the stack.

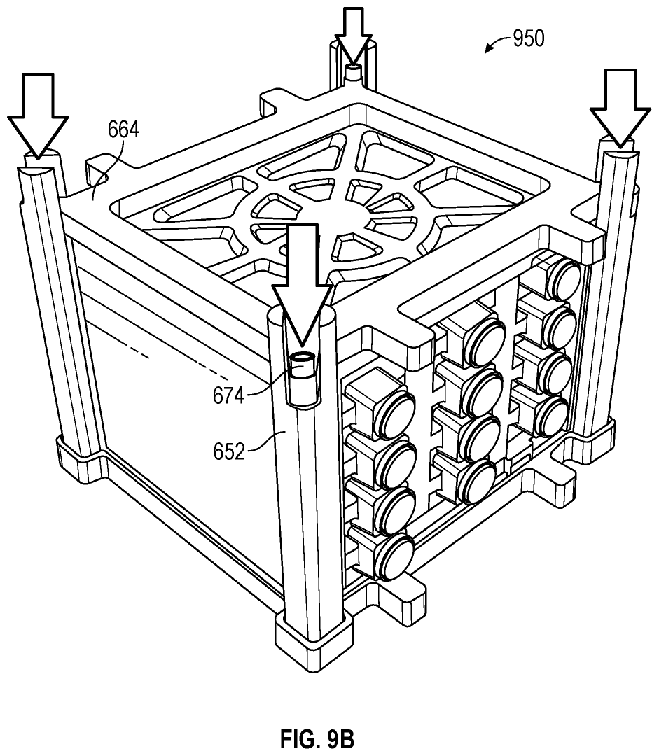

FIG. 9A illustrates generally a technique for applying compression to the stacked battery assembly of FIG. 8. A hydraulic, pneumatic, or other actuator 670 can be used in a press configuration to place a fixturing 950 comprising the battery stack under compression 990, such as to facilitate permanently bonding the stack elements into an assembly. For example, the actuator can apply a specified force (e.g., in excess of 5.3 kiloNewton, for example), such as having a press ram speed of less than about 5 mm per minute. If the sub-assemblies are spaced apart by crush ribs as mentioned above, such ribs can collapse under load and can help facilitate uniform and smooth compression. An end of compression can be determined such as by ultimate load under compression. The numerical values mentioned above are merely illustrative and other geometric or process parameters can be used, such as depending on a stack cell count or other factors such as casing frame material or configuration. In an example, a welding operation (e.g., optical or hot-plate welding) or other bonding operation can be performed while compression is being applied to the stack by the press. Alternatively or in addition, compression can be maintained outside the press through other techniques, such as shown below in FIG. 9B, where bolts (such as a cap screw 674) or other fasteners (such as clips or clamps) can be used to maintain compression of the stack in part using the compression plate 664 and frame comprising posts 652 after the fixturing 950 is removed from the press. In this manner, the compressed stack of sub-assemblies is secured.

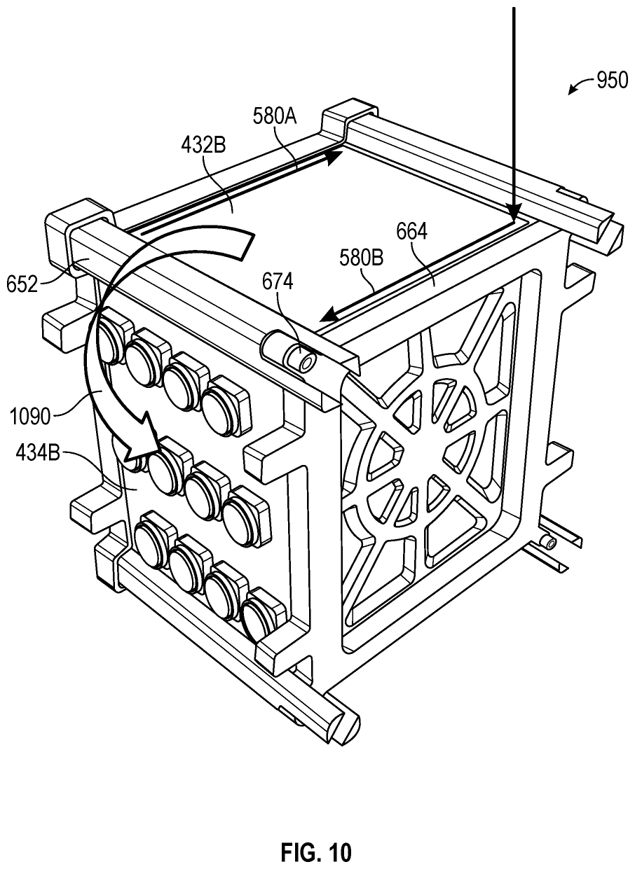

FIG. 10 illustrates generally a technique for affixing one or more panels to a battery assembly. The fixturing 950 mentioned above can be removed from a press or the technique shown in FIG. 10 can be performed while the fixturing 950 is under compression within a press. Fasteners such as the cap screw 674 inserted in the post 652 can remain to keep the stack under compression (e.g., using the end plates as shown and described above). As an illustration, two welds can be performed on each panel in locations at or nearby end-cap regions as shown illustratively in FIG. 10. Optical energy can be applied and can follow an optical energy path 580A at one edge of a side panel 432B, and a second weld can be formed I the panel 432B using optical energy applied following an optical energy path 580B.

The fixturing 950 can be rotated (or the optical energy source can be re-aligned) such as to perform optical welding on another portion of the battery stack, such as to affix a top panel 434B or other panel. As an illustration, if four panels are used as shown and described elsewhere herein, then eight welds can be formed, with 5 to 10 seconds consumed per weld in prototype production. To facilitate fabrication, the battery assembly can be rotated 1090 during or between weld operations, or multiple optical sources can be used to weld panels to the assembly in a contemporaneous manner. In an illustrative example, the panel material and casing segments are made from the similar or the same materials but having different pigment or optical transmission properties. In an example, the casing segments are made from a fiber-loaded or fiber-reinforced material, where the panel elements need not be fiber-loaded or fiber-reinforced.

If an optical (e.g. laser) welding approach is used, the panels can be transparent or semi-transparent (e.g. translucent) at an optical wavelength used for the welding operation. For example, the panels 432B and 434B as shown in FIG. 10 can be optically transparent or translucent and having a specified hue, provided that such panels transmit optical energy for establishing a bond thermally with a modular casing portion or other portion of the assembly, when optical energy is directed through the side panel during a welding operation. The modular casing portions or other surfaces to which the side panels will be welded, along with the top and bottom panels, can be polymer materials. However, other materials can be used, such as metallic casing frames to which a polymer side panel can be welded. Generally, to use a transmissive laser welding approach, at least one of the materials being welded is optically transmissive at a wavelength range of interest, and the other material is optically absorbing. The side panels or casing frames need not be a homogeneous material. For example, a composite material can be used, such as a polymer material having a glass fiber or other reinforcement as mentioned above. For example, use of a glass fiber reinforcement in a polymer material can decrease creep at higher temperature.

In the illustration of FIG. 10, joints are established along optical energy paths 580A and 580B, at a perimeter of the panel 432B (e.g., at least two edges). Lap joints or other weld structures can be formed elsewhere on a surface of a panel 432B, such as at specified locations along the battery assembly. For example, depending on a count of cells (e.g., defined by a count stacked casing segments), additional welds can be formed such as added when a greater count of casing segments are used. Such additional welds can help provide additional stability and structural rigidity and can aid in maintaining the stack under a specified compressive loading. One or more of a laser source or handling of the battery assembly can be robotized or otherwise automated such as using a robotic handler, such as to facilitate a laser welding process. For example, a multi-axis positioner can be used to perform a welding operation.

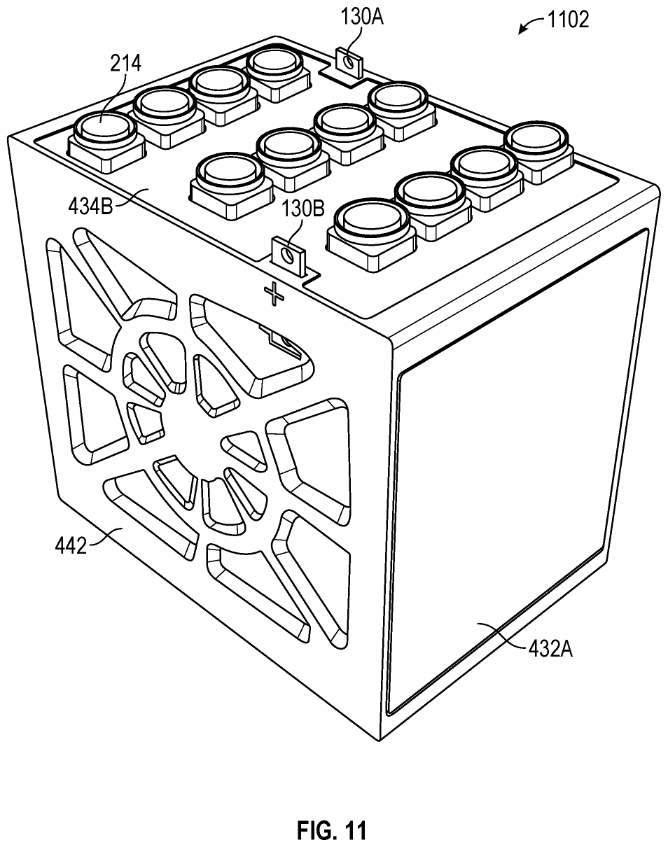

FIG. 11 illustrates generally a battery assembly 1102 such as can be constructed using one or more techniques described elsewhere herein. Upon completion of welding or other operations, the fixture (e.g., frame and end plates used to the compress the battery assembly 1102 can be removed. In an illustrative example, terminals 130A and 130B or other components (e.g., vent 214 caps) can be installed. Side panels such as a panel 432A can maintain the stack of modular sub-assemblies in compression to provide a bipolar battery assembly 1102. End electrode assemblies 442 need not be affixed using the optical energy welding approach.

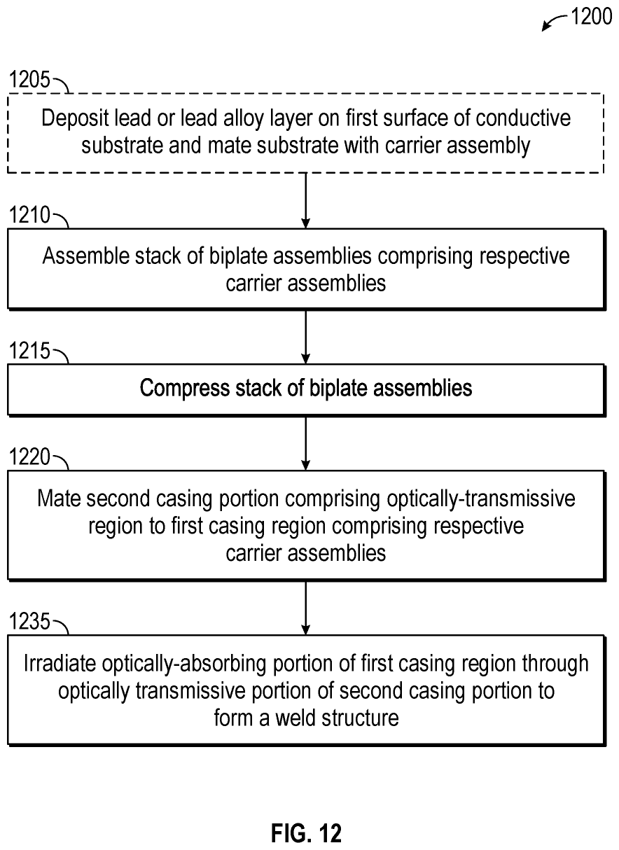

FIG. 12 illustrates generally a technique 1200, such as a method, for fabricating a battery assembly. At 1210, a stack of biplate assemblies can be assembled, such as comprising respective carrier assemblies (e.g., where such carrier assemblies comprising modular casing portions). At 1215, the stack of biplate assemblies can be compressed, such as using fixturing as shown and described above. At 1220, a second casing portion (e.g., a side panel, a top panel, or a bottom panel) can be mated to the stack of biplate assemblies. The second casing portion comprises an optically transmissive region and a first casing region (e.g., a shoulder or other location where a weld is to be formed) comprises an optically absorbing region. At 1235, the optically-absorbing portion of the first casing region can be irradiated through the optically transmissive portion of the second casing portion to form a weld structure. Optionally, at 1205, a conductive substrate can be treated, such as having a lead or lead alloy layer deposited on a substrate before mating the substrate with a carrier assembly such as a modular casing portion.

### Various Notes

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A method for fabricating a battery assembly, the method comprising:
assembling a stack of biplate assemblies including aligning the biplate assemblies using a fixture, the fixture having at least one feature sized and shaped to engage a corresponding feature in a first casing portion in the stack of biplate assemblies;
compressing the stack of biplate assemblies;
mating a second casing portion comprising an optically-transmissive region to the first casing portion;
irradiating an optically-absorbing region of the first casing portion through an optically-transmissive portion of the second casing portion to form a weld structure along at least one edge of the second casing portion.

2. The method of claim 1, wherein the irradiating comprises using a laser to thermally form the weld structure.

3. The method of claim 1, comprising securing the compressed stack of biplate assemblies by end structures applied to the compressed stack of biplate assemblies.

4. The method of claim 3, wherein the end structures are fastened to the fixture.

5. The method of claim 4, wherein the end structures, the fixture, and the compressed stack form a unitized assembly.

6. The method of claim 5, wherein the second casing portion comprises a panel affixed by the weld structure to the stack of biplate assemblies; and
wherein the panel, at least in part, maintains the stack of biplate assemblies in compression after removing the end structures and the fixture.

7. The method of claim 6, wherein the panel affixed by the weld structure to the stack of biplate assemblies is amongst four panels each located on different sides of the stack of biplate assemblies, the four panels maintaining the stack of biplate assemblies in compression after removing the end structures and the fixture.

8. The method of claim 1, wherein the biplate assemblies comprise respective first casing portions.

9. The method of claim 8, wherein the respective first casing portions comprise modular casing frames, the modular casing frames supporting a conductive substrate clad with active materials on opposing surfaces of the conductive substrate, the active materials having opposite polarities.

10. The method of claim 9, wherein the modular casing frames define vent structures that are staggered in location to avoid interference between adjacent ones of the modular casing frames when stacked.

11. The method of claim 1, comprising manipulating the compressed stack of biplate assemblies using a robotic handler at least in part to establish a location where the irradiating the optically-absorbing is performed.

12. A method for fabricating a battery assembly, the method comprising:
assembling a stack of biplate assemblies including aligning the biplate assemblies using a fixture, the fixture having at least one feature sized and shaped to engage a corresponding feature in a first casing portion in the stack of biplate assemblies;
compressing the stack of biplate assemblies;
mating a panel comprising an optically-transmissive region to the first casing portion;
securing the compressed stack of biplate assemblies by end structures applied to the compressed stack of biplate assemblies, the end structures fastened to a fixture that aligns the compressed stack of biplate assemblies; and
irradiating an optically-absorbing region of the first casing portion through an optically-transmissive portion of the panel using a laser to thermally form a weld structure along at least one edge of the panel.

13. The method of claim 12, wherein the end structures, the fixture, and the compressed stack form a unitized assembly.

14. The method of claim 12, wherein the biplate assemblies comprise respective first casing portions.

15. The method of claim 12, wherein the respective first casing portions comprise modular casing frames, the modular casing frames supporting a conductive substrate clad with active materials on opposing surfaces of the conductive substrate, the active materials having opposite polarities.

16. An assembly comprising:
two or more biplate assemblies;
a fixture comprising at least one feature sized and shaped to engage a corresponding feature in the two or more biplate assemblies to align the biplate assemblies in a stack for a welding operation; and
respective end structures fastened to the fixture to maintain compression of the two or more biplate assemblies.

17. The assembly of claim 16, wherein the fixture defines an aperture permitting mating of a second casing portion comprising an optically-transmissive region to respective first casing portions of the two or more biplate assemblies.

18. The assembly of claim 17, wherein the respective first casing portions comprise modular casing frames, the modular casing frames supporting a conductive substrate clad with active materials on opposing surfaces of the conductive substrate, the active materials having opposite polarities.

19. The assembly of claim 18, wherein the modular casing frames define vent structures that are staggered in location to avoid interference between adjacent ones of the modular casing frames when stacked.

20. The assembly of claim 17, wherein the second casing portion comprises at least one of a fiber-loaded or a fiber-reinforced material.
